(19) United States
(12) Patent Application Publication
(10) Pub. No.: US 2009/0308673 A1
(43) Pub. Date: Dec. 17, 2009

(54) Method for starting an internal combustion engine in a hybrid drive

(76) Inventor: Andreas Seel, Hemmingen (DE)

Correspondence Address: KENYON & KENYON LLP, ONE BROADWAY, NEW YORK, NY, 10004, US

(21) Appl. No.: 12/227,260

(22) PCT Filed: Apr. 3, 2007
(86) PCT No.: PCT/EP2007/053225

§ 371 Date: Mar. 6, 2009

(30) Foreign Application Priority Data
May 12, 2006 (DE) 102006022395.0

(51) Int. Cl. B60K 6/42; G06F 19/00

(52) U.S. Cl. 180/65.22; 701/113; 180/65.21

(57) ABSTRACT

A method is described for starting an internal combustion engine of a hybrid drive having at least one electric drive. This drive can be coupled to the internal combustion engine via a first clutch for the pulse start of the engine. A speed change of the at least one electric drive occurring during the pulse start of the internal combustion engine is compensated for by continuously occurring changes of the transmission ratio in a vehicle transmission.

### FIELD OF THE INVENTION

The field of the invention relates to a method for starting an internal combustion engine in a hybrid drive.

### BACKGROUND INFORMATION

A drivetrain for a motor vehicle is discussed in EP 1 173 674 B1. The drivetrain includes an internal combustion engine, to which an electric machine is assigned, which generates a torque upon starting the internal combustion engine. A clutch is provided between the internal combustion engine and a transmission, via which a torque generated by the internal combustion engine is transmitted to at least one vehicle drive wheel. Units are provided which actuate the clutch during the start of the internal combustion engine in such a way that a first part of the torque generated by the electric machine during the starting of the internal combustion engine is transmitted to the at least one vehicle drive wheel and a second part of the torque generated by the electric machine, which is sufficient to start the internal combustion engine, is transmitted to the internal combustion engine. The clutch is operated using a control unit, taking into consideration temperature-dependent and/or speed-dependent ignition maps for the drive torque of the internal combustion engine and/or for the starting torque and/or for the clutch torque, which is predominantly a function of the clutch engagement distance.

In vehicle drives currently in use, such as a hybrid drive having at least one internal combustion engine and having at least one further electric drive, the motor vehicle may be moved solely with the aid of the at least one electric drive, depending on the embodiment of the drivetrain. In this case, the at least one electric drive delivers all of the drive energy, while in contrast the internal combustion engine remains turned off. In the operating mode “electric travel,” the stationary internal combustion engine may be started by the at least one electric drive. This may be performed, for example, with the aid of the pulse start, the torque pulse of the at least one electric drive, which is in rotation, being used to set the stationary internal combustion engine into rotation. The speed of the at least one electric drive is first increased to perform the pulse start. So as not to cause any speed increase of the at least one electric drive, a clutch situated between the at least one electric drive and a vehicle transmission is typically operated torque-regulated and transmits the driver command torque in this operating phase of the motor vehicle equipped with a hybrid drive.

After the speed increase of the at least one electric drive has taken place, a clutch located between the at least one electric drive and the internal combustion engine is engaged. This procedure has the disadvantage that the clutch between the vehicle transmission and the at least one electric drive, which is operated in the slip state, may not be operated permanently in this slip state, which is necessary on the one hand for maintaining a continuous output speed, but on the other hand would result in a mechanical or thermal overload of this clutch. This precludes permanent operation of this clutch between the at least one electric drive and the transmission of the vehicle equipped with a hybrid drive. To perform the described pulse start, it is first necessary to cause a speed increase at the at least one electric drive of the hybrid drive, so that the entire starting procedure is lengthened, because the at least one electric drive must first be accelerated and only then may a drive connection be provided to the internal combustion engine, and a complex torque regulation of the clutch of the at least one electric drive to the vehicle transmission is concurrently necessary so as not to generate torque jumps at the output.

### SUMMARY OF THE INVENTION

In consideration of the described technical problems, the exemplary embodiments and/or exemplary methods of the present invention is based on the object of avoiding a speed drop of the drive during the start of the internal combustion engine within a drivetrain of a vehicle equipped with a hybrid drive.

This object is achieved according to the exemplary embodiments and/or exemplary methods of the present invention in that in the event of a speed drop of the at least one electric drive during a pulse start in the internal combustion engine of the hybrid drive, a gear shifting procedure occurs, which compensates for the speed drop of the at least one electric drive during the pulse start of the internal combustion engine. In particular, the speed drop of the at least one electric drive occurring upon starting the internal combustion engine is compensated for by a continuously changing transmission ratio of the transmission, so that the output speed of the at least one electric drive may be kept constant and thus the propulsion of the motor vehicle having a hybrid drive may be kept constant. Transmissions, using which a continuous change of the transmission ratio may be performed, are, for example, automatic transmissions or continuously variable transmissions.

Using the achievement of the object suggested according to the exemplary embodiments and/or exemplary methods of the present invention, the speed of the at least one electric drive may advantageously be permanently increased, to thus start the internal combustion engine of the hybrid drive immediately on demand. Furthermore, the clutch which is typically provided in hybrid drives between the vehicle transmission and the at least one electric drive may be dispensed with by the achievement of the object suggested according to the exemplary embodiments and/or exemplary methods of the present invention.

The requirement of operating this clutch in a torque-regulated way is thus also dispensed with. Finally, the time span required to date to increase the speed of the at least one electric drive of the hybrid drive may be dispensed with by the achievement of the object suggested according to the present invention, because the at least one electric drive may be permanently operated at a higher speed. The vehicle transmission, which may be an automatic transmission or, for example, as a continuously variable transmission having continuous transmission, compensates for the speed drop of the at least one electric drive upon the pulse start of the internal combustion engine during the operating mode “electric travel” and keeps the wheel speed constant, so that an interruption of the propulsion of the motor vehicle having a hybrid drive is precluded.

During the pulse start of the internal combustion engine of the hybrid drive, the speed drop of the at least one electric drive, which arises due to the cranking of the crankshaft of the internal combustion engine, is compensated for using a continuous change of the transmission ratio in the vehicle transmission. The vehicle transmission shifts continuously from a first transmission ratio to a second transmission ratio, i.e., for example, from a second gear to a first gear in the case of an automatic transmission, upon the pulse start of the internal combustion engine of the hybrid drive, the second transmission ratio being higher than the first transmission ratio, because the input speed of the vehicle transmission drops upon the pulse start due to the speed drop of the at least one electric drive. Transmission ratio i is given by ω_{drive}/ωₒᵤₜₚᵤₜ. If output speed ωₒᵤₜₚᵤₜ remains constant and drive speed ω_{drive}, which is applied by the at least one electric drive as a result of the pulse start of the internal combustion engine, drops, transmission ratio i drops.

The exemplary embodiments and/or exemplary methods of the present invention is explained in greater detail hereafter on the basis of the drawings.

### BRIEF DESCRIPTION OF THE DRAWINGS

FIG. 1 shows the components of a hybrid drive of a vehicle having a clutch between the at least one electric drive and the internal combustion engine and a further clutch between the at least one electric drive and the vehicle transmission.

FIG. 2 shows a speed diagram of the speeds of the at least one electric drive and the internal combustion engine to be started during the start phase, plotted over time.

FIG. 3 shows the curve of a driver torque command, plotted over time.

FIG. 4 shows the speed diagram of the at least one electric drive in the event of a higher requested speed of the electric drive.

FIG. 5 shows a transmission ratio change occurring within the vehicle transmission.

### DETAILED DESCRIPTION

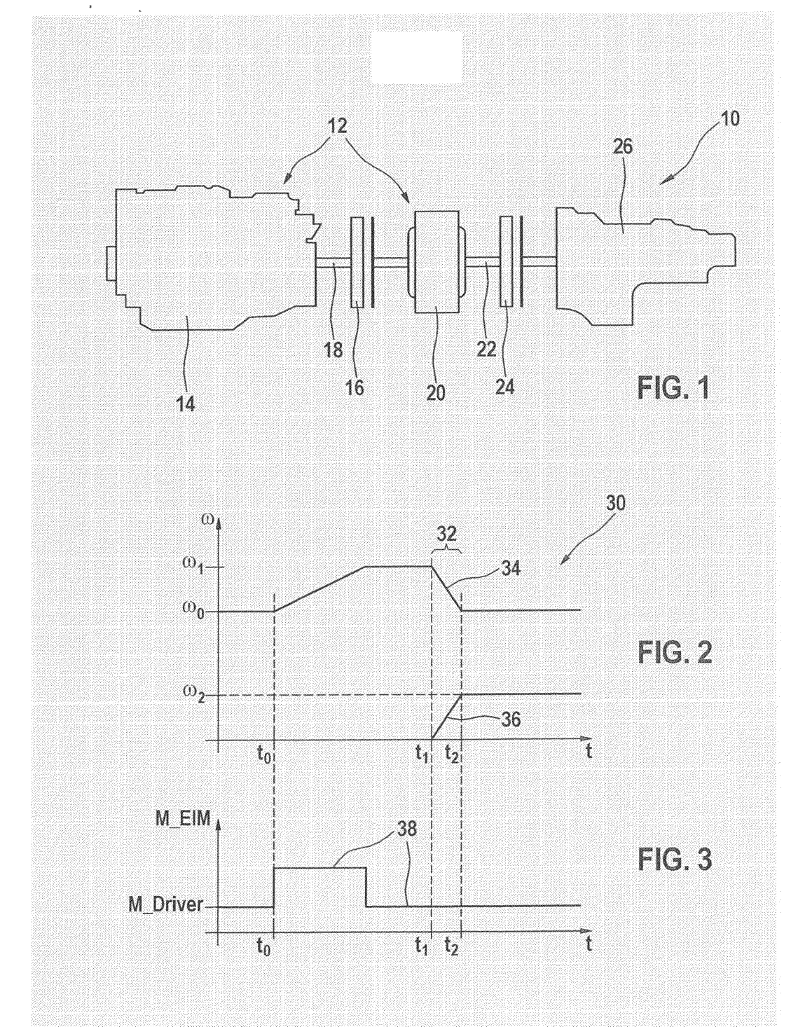

The illustration according to FIG. 1 shows the components of a hybrid drive having an internal combustion engine, at least one electric drive, a clutch situated between them, and having a further clutch between the at least one electric drive and a vehicle transmission.

A drivetrain 10 of a motor vehicle equipped with a hybrid drive 12 includes an internal combustion engine 14. Internal combustion engine 14 may be coupled using a first clutch 16 to at least one electric drive 20, which represents a further component of hybrid drive 12 shown in FIG. 1. An output shaft 22 of the at least one electric drive 20 may be coupled via a further second clutch 24 to a vehicle transmission 26. In the embodiment variant of hybrid drive 12 shown in FIG. 1, internal combustion engine 14 may be started from the operating mode “electric travel.” This is typically performed using a pulse start. For this purpose, the torque pulse of the at least one electric drive 20 is used to set stationary internal combustion engine 14 into rotation and to start it. For this purpose, however, it is necessary to increase the speed of the at least one electric drive 20. So as not to obtain a speed increase at the output during the speed increase of the at least one electric drive 20, further second clutch 24 is operated in the slip state in the configuration shown in FIG. 1. This starting procedure in the scope of a pulse start of internal combustion engine 14 has the disadvantage that further second clutch 24 may not be permanently operated in the slip state, because it would otherwise be mechanically or thermally overloaded.

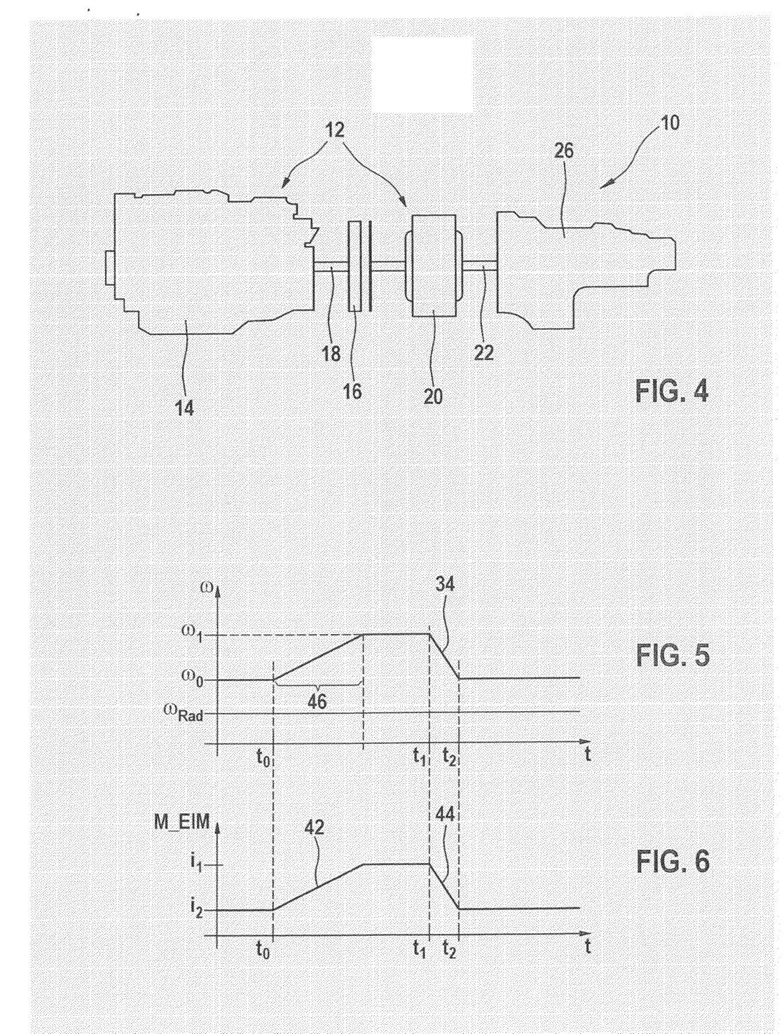

FIGS. 2 and 3 show speed and torque diagrams, respectively, the speed or the torque of the at least one electric drive being plotted over the time axis in each case.

It may be seen from the illustration of FIG. 2 that the at least one electric drive 20 is operated at a starting speed ω₀. At instant t=t₀, a torque increase of the at least one electric drive 20 operated in the operating state “electric travel” is commanded according to driver command 38; compare driver command torque 38 in FIG. 3. From instant t=t₀, the speed of the at least one electric drive 20 is continuously increased as shown in the illustration in FIG. 2, until the at least one electric drive 20 has assumed an increased speed ω₁.

At an instant t=t₁, i.e., at increased speed ω₁ of the at least one electric drive 20, further second clutch 24 is engaged, whereby a decrease 34 of the speed of the at least one electric drive 20 results. Internal combustion engine 14 is simultaneously accelerated to its speed ω₂ by further second torque-regulated clutch 24. Speed decrease 34 of the at least one electric drive 20 and acceleration 36 of internal combustion engine 14 also occur during clutch phase 32, within which further second clutch 24 is operated in the slip state and is subjected to large thermal and mechanical strains.

At instant t=t₂, the internal combustion engine runs at its speed ω₂. The configuration of hybrid drive 12 shown in FIG. 1 requires further second clutch 24 to be operated in the slip state, the pulse start procedure of internal combustion engine 14 to be started also lasting longer, because the at least one electric drive 20 must first be accelerated from its starting speed ω₀ to increased speed ω₁ and only then may a clutching procedure occur. To avoid jerking in the drivetrain and an accordingly resulting impairment of the driving comfort, complex regulation of this further second clutch 24 as a torque-regulated clutch is necessary.

FIG. 4 shows the configuration of the drivetrain suggested according to the exemplary embodiments and/or exemplary methods of the present invention.

In contrast to the illustration of FIG. 1, in the drivetrain shown in FIG. 4, further second clutch 24 is dispensed with. Internal combustion engine 14 of drivetrain 10 shown in FIG. 4 is connected via its output shaft 18 to first clutch 16, which is still present, and which is in turn coupled to the at least one electric drive 20. Output shaft 22 of the at least one electric drive 20 is connected to vehicle transmission 26.

The illustrations of FIGS. 5 and 6 show the speed diagram of the at least one electric drive and the at least one drive wheel over time and the curve of the transmission ratio plotted over time during a pulse start.

The illustrations of FIGS. 5 and 6 relate to drivetrain 10 shown in FIG. 4.

According to FIGS. 5 and 6, a speed increase 46 of the at least one electric drive 20 is triggered at instant t=t₀. Accordingly, the speed of the at least one electric drive 20 increases from ω₀ to ω₁. Simultaneously, the change of the transmission ratio in the transmission of vehicle transmission 26 from transmission ratio i₂ to transmission ratio i₁ occurs during a first transition phase 42, for example, the transmission shifts down from a second gear into a first gear. In addition to the increase shown in FIG. 5 in the speed of the at least one electric drive 20 from speed ω₀ to increased speed ω₁, corresponding to speed increase 46 shown in FIG. 5, the at least one electric drive 20 may also be operated from the outset at increased speed ω₁. In this case, vehicle transmission 26 is also operated using transmission ratio i₁.

The pulse start of internal combustion engine 14 schematically indicated in FIG. 4 is performed between instants t₁ and t₂ plotted in FIG. 5 and FIG. 6, so that a speed drop 34 of the at least one electric drive 20 results as shown in FIG. 5. Parallel to resulting speed drop 34 of the at least one electric drive 20, a change of the transmission ratio in vehicle transmission 26 from first transmission ratio i₁ to second transmission ratio i₂ occurs during a second transition phase 44, so that—as indicated in FIG. 5—the wheel speed of at least one driven wheel ω_{wheel} remains constant.

In hybrid drive 12 as shown in the illustration in FIG. 4, vehicle transmission 26 may be an automatically shifting transmission or as a continuously variable transmission (CVT).

It is thus ensured that the propulsion of the vehicle is continuously maintained during the pulse start of internal combustion engine 14. The embodiment variant of drivetrain 10 suggested according to the exemplary embodiments and/or exemplary methods of the present invention also allows the operation of the at least one electric drive 20 at increased speed ω₁, so that the “increase phase” of the at least one electric drive 20 required within time span 46 may be dispensed with. The time span within which internal combustion engine 14 of hybrid drive 12 may be started using a pulse start thus decreases. As may be seen from FIGS. 5 and 6, upon a speed increase 46 of the at least one electric drive 20 from starting speed ω₀ to increased speed ω₁, a change of the transmission ratio from transmission ratio i₂ to i₁ is performed in parallel; this is also true for the compensation of speed drop 34 from increased speed ω₁ of the at least one electric drive 20 to its starting speed ω₀, where a continuous change of the transmission ratio from transmission ratio i₁ to lower transmission ratio i₂ follows during the time span between t₁ and t₂ during second transition phase 44, to keep wheel speed ω_{wheel} constant.

As may be seen from the illustration in FIG. 4, second further clutch 24 required in FIG. 1 and its complex torque regulation may be dispensed with by the achievement of the object suggested according to the present invention. Using the method suggested according to the present invention, a “winding up” of the at least one electric drive 20, i.e., the increase of its speed, may be achieved, the transmission ratio in vehicle transmission 26 being continuously increased, which is caused by a downshift. On the other hand, by the method proposed according to the exemplary embodiments and/or exemplary methods of the present invention, during the pulse start of internal combustion engine 14, which is linked to a speed decrease on the at least one electric drive 20, output speed ωₒᵤₜₚᵤₜ of vehicle transmission 26 may be kept constant, because transmission ratio i=ωₒᵤₜₚᵤₜ/ω_{drive} decreases, and accordingly an upshift occurs within vehicle transmission 26.

1-9. (canceled)

10. A method for starting an internal combustion engine of a hybrid drive for a vehicle having at least one electric drive, the method comprising:
coupling the at least one electric drive to the internal combustion engine via a first clutch for a pulse start of the engine; and
compensating for a speed change of the at least one electric drive occurring during the pulse start of the internal combustion engine by continuously changing a transmission ratio in a vehicle transmission.

11. The method of claim 10, wherein the transmission ratio of the vehicle transmission decreases continuously during a speed drop of the at least one electric drive.

12. The method of claim 10, wherein at least one wheel speed of at least one driven wheel remains constant during the pulse start of the internal combustion engine.

13. The method of claim 10, wherein the transmission ratio in the vehicle transmission increases continuously during a speed increase of the at least one electric drive at a time instant t=t₀.

14. The method of claim 1, further comprising:
performing one of the following:
downshifting the vehicle transmission during the speed drop of the at least one electric drive; and
upshifting the vehicle transmission during the speed increase of the at least one electric drive.

15. The method of claim 11, wherein gradients of the speed changes of the at least one electric drive correspond to gradients of changes of the transmission ratio in the vehicle transmission.

16. The method of claim 11, wherein the continuous changes of the transmission ratio occur in a vehicle transmission which is at least one of an automatic transmission and a continuously variable transmission.

17. The method of claim 11, wherein, in an at least one electric drive operated at a speed which is increased in relation to a starting speed, the pulse start of the internal combustion engine is shortened by a time span which is required for a speed increase of the at least one electric drive from the starting speed to the speed.

18. A drivetrain of a vehicle having hybrid drive, comprising:
an internal combustion engine;
at least one electric drive, which is coupleable via a first clutch to the internal combustion engine;
a vehicle transmission to drive at least one wheel of the vehicle, the internal combustion engine being startable using a pulse start;
wherein the vehicle transmission is at least one of a continuously shifting automatic transmission and a continuously variable transmission, within which ramped transitions are provided between individual transmission ratios in the event of speed changes of the at least one electric drive.
